(19) United States
(12) Patent Application Publication
(10) Pub. No.: US 2014/0324502 A1
(43) Pub. Date: Oct. 30, 2014

(54) COORDINATING A PLURALITY OF CELEBRATORY EVENTS FOR AN HONOREE

(71) Applicant: HEWLETT-PACKARD DEVELOPMENT COMPANY, L.P., (US)

(72) Inventors: James L. McCullough, San Diego, CA (US); David R. Parry, Corvallis, OR (US)

(73) Assignee: HEWLETT-PACKARD DEVELOPMENT COMPANY, L.P., Houston, TX (US)

(21) Appl. No.: 13/870,431

(22) Filed: Apr. 25, 2013

(51) Int. Cl. G06Q 10/10

(52) U.S. Cl. CPC G06Q 10/1095
USPC 705/7.19

(57) ABSTRACT

A central server for coordinating a plurality of celebratory event for an honoree comprising a processor, a data storage device communicatively coupled to the processor, a user selection module to provide a user accessing the central server with a selection among a plurality of services to support the celebratory event, a third party selection module to provide the user with a plurality of third party services to support the celebratory event the third party services being provided from a plurality of third party service providers, and a calendar coordination module to provide the user with a selection of when the services are to be provided to the honoree.

### BACKGROUND

Anniversaries, birthdays, and other special events in a person's life are often celebrated by friends and family. Often cakes, birthday cards, and presents are presented to show these friends and family members their appreciation for them as well as celebrate these milestones in their lives. Other events throughout the day such as work and chores may take up a significant portion of the day leaving those times after these events for relaxation.

### BRIEF DESCRIPTION OF THE DRAWINGS

The accompanying drawings illustrate various examples of the principles described herein and are a part of the specification. The examples do not limit the scope of the claims.

FIG. 1 is a block diagram of a system to coordinate a number of celebratory events for an honoree according to one example described herein.

FIG. 2 is a diagram of user interface presented to the user of the user computing device according to one example of the principles described herein.

FIG. 3 is a flowchart describing a method of coordinating a number of celebratory events for an honoree according to one example of principles described herein.

Throughout the drawings, identical reference numbers designate similar, but not necessarily identical, elements.

### DETAILED DESCRIPTION

Generally, a special event is not celebrated on a specific time in a day. Instead, that event is recognized as an event that occurs throughout the entire day. In light of other responsibilities, however, these events may only be celebrated at one point in the day, usually later in the day. Some actions may be taken by those wanting to congratulate the honoree throughout the day such as sending congratulatory emails or texts. However, in planning out the day, a celebrator is left to arrange any number of congratulatory events or actions manually.

The invention, therefore describes a central server for coordinating a plurality of celebratory event for an honoree comprising a processor, a data storage device communicatively coupled to the processor, a user selection module to provide a user accessing the central server with a selection among a plurality of services to support the celebratory event, a third party selection module to provide the user with a plurality of third party services to support the celebratory event the third party services being provided from a plurality of third party service providers, and a calendar coordination module to provide the user with a selection of when the services are to be provided to the honoree.

The present specification further describes a computer program product for coordinating a number of celebratory events for an honoree, the computer program product comprising a computer readable storage medium comprising computer usable program code embodied therewith, the computer usable program code comprising computer usable program code to, when executed by a processor, receive a number of third-party service providers selections from a user of a first computing device, computer usable program code to, when executed by a processor, receive an indication of when a service is to be provided to an honoree as celebratory events from a user of the first computing device, and computer usable program code to, when executed by a processor, schedule with the third-party service providers those services to be provided to the honoree which were received from the user.

Still further, the present specification describes a method of coordinating a plurality of celebratory events for an honoree on a central server comprising receiving a number of third-party service providers selections from a user of a first computing device, receiving an indication from the first computing device of when a service is to be provided to an honoree as a celebratory event, and scheduling with the third-party service providers those services to be provided to the honoree, in which scheduling with the third-party service providers those services to be provided to the honoree comprises coordinating the celebratory events with the user using a first calendaring program on a first computing device operated by the user and in which any events already on the first calendaring program are coordinated with a time that the services are to be provided to the honoree, and coordinates the celebratory events with the honoree using a second calendaring program on a second computing device operated by the honoree in which any events already on the second calendaring program are coordinated with a time that the services are to be provided to the honoree.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims the term “honoree” is meant to be understood as any person who, on any specific day, has an event to celebrate. In some examples, the honoree is the recipient of gifts and other acknowledgements or services scheduled by a user of the system for coordinating a number of celebratory events.

Still further, in the present specification and in the appended claims, the term “services” may be understood as any service provided to or to be provided to a person. In some examples, the services may include reservation services, email service, text messaging services, delivery services, purchasing services, among others. In some examples of the presently described system and method, the services may by provided to a user of the system directly in order to provide a service to an honoree. In another example, the services may be provided directly to the honoree.

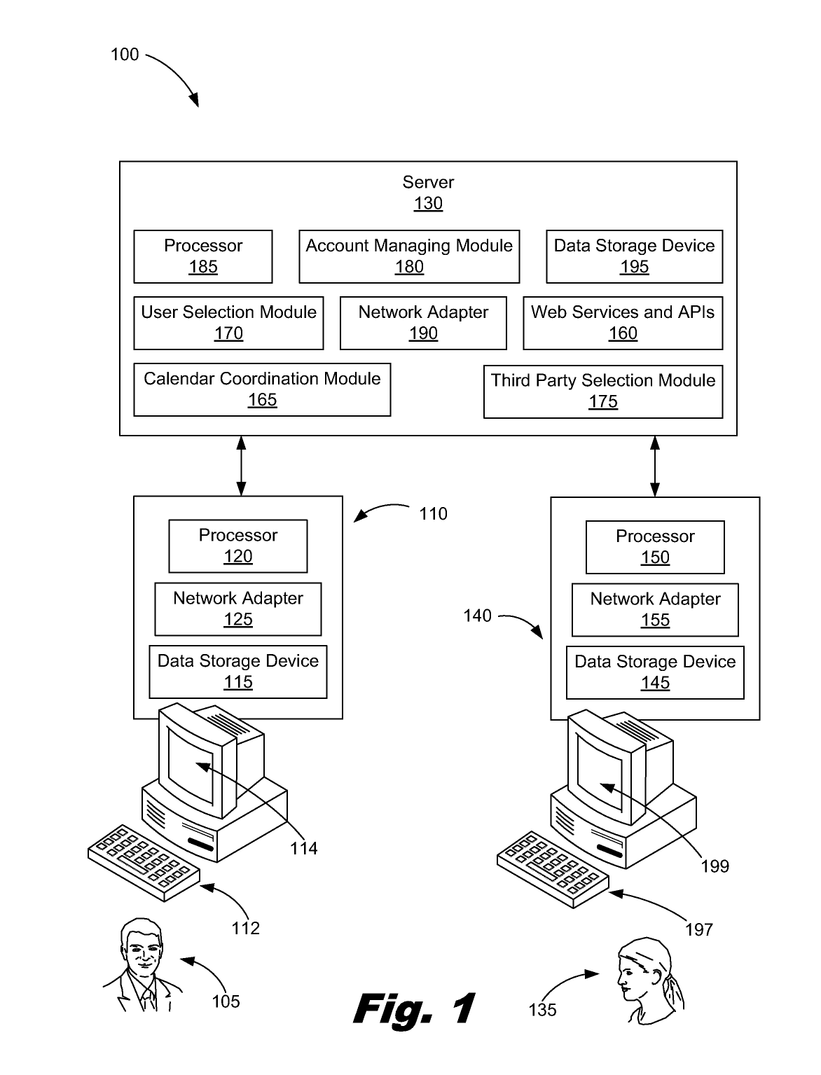

FIG. 1 is a block diagram of a system (100) to coordinate a number of celebratory events for an honoree according to one example described herein. The system comprises a number of modules and hardware to allow a user (105) of a user computing device (110) to coordinate a number of celebratory events for or on behalf of an honoree. The computing device (110) may comprise a data storage device (115), a processor (120), and a network adapter (125) which may allow the computing device (110) to interact and communicate with a server (130). The server (130) may provide services to a user (105) such as those provided by third party service providers (135). These third party service providers (135) may also interact and communicate with the server (130) through a third-party computing device (140) comprising a data storage device (145), a processor (150), and a network adapter (155). In one example, the server (130) may be accessed by a user (105) through a computing device (110) to schedule a number of events and actions. Events may include, for example, services that may be ordered from a plurality of third-party service providers (135) including delivery of goods such as flowers, reservations at restaurants, reservations of tickets among others. The actions that may be provided to the user (105) as a service may be email, text messaging, and schedule coordination, among others.

The server may generally comprise a number of web services and application programming interfaces (APIs) (160), a calendar coordination module (165), a user selection module (170), a third party selection module (175), and an account managing module (180). Each of these may be used by either the user (105) or third party services provider (135) to receive selections and information describing services in which the user (105) would like to engage in and services provided by the third party services provider (135).

The server (130) may further comprise a number of hardware devices such as a processor (185), a network adapter (190) and a data storage device (195). Each of the above elements will now be described in more detail.

The computing device (110) may be any type of computing device that is able to communication with the server (130) in a network environment. Therefore, the computing device (110) may be a tablet device, a desktop computing device, a smartphone, a laptop, or a personal digital assistant among others. The computing device (110) may comprise a processor (120) to process data and execute programming code saved on the data storage device (115) or received from the server (130). Specifically, the processor (120) may receive computer usable program code to execute at least a portion of the methods described herein.

The data storage device (115) may comprise any program-addressable storage device from which instructions and other data can be loaded directly into registers for subsequent running or processing. The data storage device (115) may, therefore, include various types of memory devices, including volatile and nonvolatile memory. For example, the data storage device (115) of the present example may include Random Access Memory (RAM), Read Only Memory (ROM), and Hard Disk Drive (HDD) memory, among others. The present specification contemplates the use of many varying type(s) of memory in the data storage device (115) as may suit a particular application of the principles described herein. In certain examples, different types of memory in the data storage device (115) may be used for different data storage needs. In certain examples, the processor (120) may boot from the Read Only Memory (ROM), maintain nonvolatile storage in the Hard Disk Drive (HDD) memory, and execute program code stored in Random Access Memory (RAM).

Generally, the data storage device (115) may comprise a computer readable storage medium. For example, the data storage device (115) may be, but not limited to, an electronic, magnetic, optical, electromagnetic, infrared, or semiconductor system, apparatus, or device, or any suitable combination of the foregoing. More specific examples of the computer readable storage medium may include, for example, the following: a portable computer diskette, a hard disk, a random access memory (RAM), a read-only memory (ROM), an erasable programmable read-only memory (EPROM), flash memory, byte-addressable non-volatile memory (phase change memory, memristors), a portable compact disc read-only memory (CD-ROM), an optical storage device, a magnetic storage device, or any suitable combination of the foregoing, among others. In the context of this document, a computer readable storage medium may be any tangible medium that can contain, or store a program for use by or in connection with an instruction execution system, apparatus, or device.

The network adapter (125) may provide communication between the computing device (110) and the server (130). As will be described below in more detail, the network adapter (125) may provide the user with the ability to communicate with the server (130) such that the user may organize a celebration of an event on behalf of an honoree by, for example, coordinating reservations for services and arranging for certain messages to be sent to the honoree throughout the day.

In addition to the processor (120), network adapter (125), and memory (115), the computing device (110) may further comprise a number of user interface devices including an input device (112) and an output device (114). The input device (112) may comprise a keyboard, a microphone, or a mouse, among others. The output device (114) may include a screen or any other device that may present data to a user (105).

Although FIG. 1 shows a single computing device (110) operated by a user (105), the present specification contemplates that any number of computing devices (110) may be communicatively coupled to the server (130) as described above. Additionally, although the computing device (110) shown may comprise a number of devices which together may communicate with the server (130) to accomplish the methods described herein.

As briefly mentioned, the server (130) may also comprise a processor (185), a network adapter (190) and a data storage device (195). The data storage device (195), similar to the data storage device (115) of the user computing device (110), may comprise any program-addressable storage device from which instructions and other data can be loaded directly into registers for subsequent running or processing. The data storage device (195) of the server may, therefore, include various types of memory devices, including volatile and nonvolatile memory including, but not limited to, Random Access Memory (RAM), Read Only Memory (ROM), and Hard Disk Drive (HDD) memory.

The processor (185) processes data and executes programming code saved on the data storage device (195) or received from either the user computing device (110) or third party service provider (135). Specifically, the processor (185) may receive computer usable program code to execute at least a portion of the methods described herein.

The network adapter (190) may, similar to the network adapter (125) of the user computing device (110), provide communication between the various computing devices communicatively coupled to the server (130). The network adapter (190) may provide a user of a computing device (110, 140) with the ability to communicate with the server (130) such that the user may organize a celebration of an event on behalf of an honoree by, for example, coordinating reservations for services and arranging for certain messages to be sent to the honoree throughout the day.

The third-party computing device (140) may also comprise a processor (150), a network adapter (155), and a data storage device (145). Each of these elements may be similar to the data storage device (115), processor (120), and network adapter (125) described above in connection with the user's computing device (110). Although FIG. 1 shows only a single third-party computing device (140) the present specification contemplates that a number of third-party computing devices may be coupled to the server (130) in order to provide a user of the user computing device (110), through the server (130), to be provided with a number of third-party services such as delivery services, email services, social networking services, peer-to-peer sharing services, and text messaging services, among others.

The data storage device (145), similar to the data storage device (115) of the user computing device (110), may comprise any program-addressable storage device from which instructions and other data can be loaded directly into registers for subsequent running or processing. The data storage device (145) of the third-party computing device (140) may, therefore, include various types of memory devices, including volatile and nonvolatile memory including, but not limited to, Random Access Memory (RAM), Read Only Memory (ROM), and Hard Disk Drive (HDD) memory.

The processor (150) processes data and executes programming code saved on the data storage device (145) or received from either the user computing device (110) or server (130). Specifically, the processor (150) may receive computer usable program code to execute at least a portion of the methods described herein.

The network adapter (155) may, similar to the network adapter (125) of the user computing device (110), provide communication between the various computing devices communicatively coupled to the third-party computing device (140). The network adapter (155) may provide a user (135) of the third-party computing device (135) with the ability to communicate with the server (130) such that the user (135) may set up a number of services to provide to a user who is organizing a celebration of an event on behalf of an honoree.

The user (135) of the third-party computing device (140) may interact with the user computing device (110) and server (130) via a number of user interface devices including an input device (197) and an output device (199). The input device (197) may comprise a keyboard, a microphone, or a mouse, among others. The output device (199) may include a screen or any other device that may present data to a user (135).

In operation, the system (100) provides the user (105) of the user computing device (110) with the ability to coordinate events for a celebration on behalf of an honoree. In one example, the server may comprise a number of web services and APIs (160) to facilitate the transfer and interaction between the user (105) and the server (130). The APIs, for example, may allow a user (105) to communicate with a third party selection module (175). As described above, the third party selection module allows a user to select among a number of third-party service providers to provide services for and on behalf of the honoree. For example, if the user (105) wishes to send a bouquet of flowers to an honoree in celebration of an event, the user (105) may select, via the user interface devices (112, 114) a particular service provider which is able to provide such a service. In one example, the price lists of such a services form each third-party service provider may be provided to the user (105) as well as the terms of any service contract that is to be entered into once that service is selected. The server (130) may provide a list of third-party service providers to the user (105) via the user interface devices (114) such that each service provider is placed into a category of services such that the user may first select a type of service to be provided (e.g. flower delivery, text messaging, email services, etc.) and then select a specific third-party service provider from the list of service providers.

The server (130) may further comprise a calendar coordination module (165) and an associated API (160) to assist the user (105) in planning when, throughout the day, selected services are to be provided to an honoree. In one example, the calendar coordination module (165) may provide to the user (105) via the interface (114) the ability to select times at which he or she would like services to be provided to an honoree throughout any given period of time and coordinate those times with the user's calendaring program on the user computing device (110). The calendar coordination module (165) may, therefore, warn a user (105) of any conflicts that may arise between the user's saved events on his or her calendaring program on the user computing device (110) and the services selected by the user (105). For example, where a user (105) has selected a lunch reservations from a third-party provider such that the user (105) will have lunch with the honoree, the server (130) may warn the user (105) of any potential conflicts with any existing events that are present in the user's calendaring program on the user computing device (110). In this example, the user (105) may then select a different time for that reservation so that both events may be attended by the user (105).

In one example, the calendar coordination module (165) may further provide to the user (105) of the computing device (110) with a selectable calendar which has incorporated the daily events already scheduled on the user's calendaring program on the user computing device (110) such that the user (105) may better coordinate events throughout the day. In yet, another example, the honoree's calendaring program on the honoree's computing device may also provide the calendar coordination module (165) with the existing events entered in by the honoree relating those times throughout the day that the honoree may not be available. This provides the user (105) with the ability to selectively plan events with the honoree subject to the user's (105) and honoree's schedules.

The user selection module (170) may receive a number of selections from the user (105), interpret those selections, and communicate those selections to the appropriate third-party provider. The user's (105) selections may be saved by the user selection module (170) such that a record of past selections can be reviewed by the user (105). The account managing module (180) may provide to the user (105) via the user interface (114) with various account information such as credit card information of the user (105), address of the user (105), phone number of the user (105), and the user's username, password and other login information, among others. This data may be saved on the server's (130) data storage device (195). The calendaring events from both the user's and honoree's calendaring programs on their respective computing devices (105) as well as the user's (105) calendaring events created using the system (100) may also be saved on the data storage device (195) and accessed by the user (105) via the account managing module (180).

The calendar coordination module (165), account managing module (180), user selection module (170), third-party selection module (175), and web services and APIs (160) may each comprise computer usable program code which, when executed by the processors (120, 150, 185), executes the methods and functions described herein. The computer usable program code may be encoded on the computer readable storage medium as described above and be embodied as a computer program product as described above.

During certain service selections, the user may choose to have the service provided by his or her personal hardware. For example, if the user (105) has chosen to send a text message to the honoree, the system (100) may provide the user with the ability to use his or her existing texting services provided by his or her phone service to send the text message. In the example where the computing device (110) is a smartphone, the service may be provided with authorization from the user (105) to access the text messaging program executing on the smartphone device. After this authorization is provided, the user (105) may use the system (100) to send the text message as explained in this description.

Similarly, if an email messaging program is being executed on the computing device (110), the system (100) may further use this program as the program by which emails are sent to the honoree. In these examples, the account managing module (180) may provide the user (105) with the ability to select which text or email messaging services to use in connection with the operation of the system (100).

The system (100) may further be provided with access to a social networking account operated by the user (105). In this example, messages may be sent to the honoree via a social networking service messaging program. In this example, authorization may be provided by the user (105) and the message may be created by the user through the system (100).

In another example, the system (100) may retain data associated with various types of login information to access various social networking, texting, and email services operated by the user (105). The login information for these various services may be used by the system, (100) as a single sign-on service for the user. In one example, a single request by a user (105) for a service may be rendered on any number of other services. For example, where a user (105) has chosen to send an honoree an e-card to celebrate the honoree's birthday the system may send the e-card to the honoree's email account via the user's (105) email program running on the computing device (110), a social networking service associate with the user (105), and a email web accessed email account, among others.

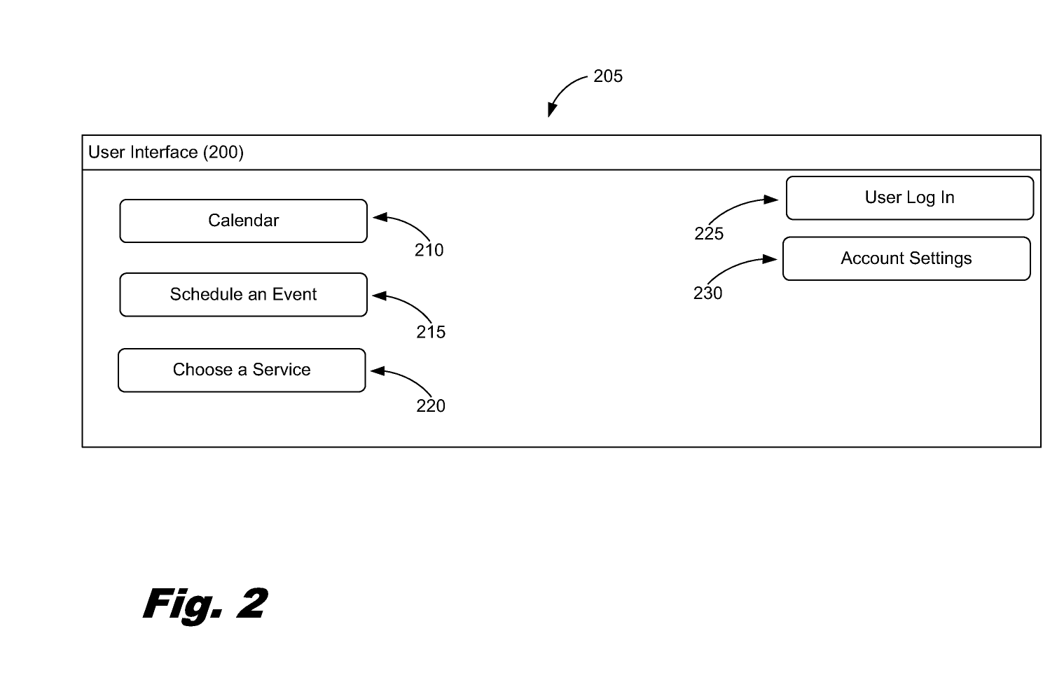

FIG. 2 is a diagram of user interface (200) presented to the user (FIG. 1, 105) of the user computing device (FIG. 1, 110) according to one example of the principles described herein. The user interface (200) may be presented to a user (FIG. 1, 105) by the server (130) via, for example, a browser window (205). A number of options may be provided to the user (FIG. 1, 105) via a number of buttons such as a calendar (210) button, a schedule an event (215) button, choose a service (220) button, a user log in (225) button, and an account settings (230) button. In order to access these options, a user (FIG. 1, 105) may use an input device (FIG. 1, 112) to select the respective button with, for example, a mouse. The calendar (210) button may present the user (FIG. 1, 105) with access to the calendar as described above including pre-propagated events from the user's (FIG. 1, 105) and honoree's calendar program on their respective computing devices (110) as described above. In one example, selection of the calendar (210) button, the user (FIG. 1, 105) is directed to another user interface with a visual representation of a calendar having the initial date as the current date.

In one example, in order to pre-propagate the user's (FIG. 1, 105) calendar events in his or her calendar program, the user (FIG. 1, 105) may access the account settings (230) button and provide access to the calendar on his or her computer to the system (FIG. 1, 100). This will provide the system (FIG. 1, 100) with the authority to access the calendaring program on the user's (FIG. 1, 105) computing device (FIG. 1, 110). In another example, the user may request that the honoree provide the system (FIG. 1, 100) access to the honoree's calendaring program on his or her computing device by sending a message to the honoree via, for example, an email service. The email service may be accessed by the user (FIG. 1, 105) via the choose a service (220) button on the user interface (200). An email service may be selected by the user (FIG. 1, 105) an invite email may be sent to the honoree requesting access to their calendaring program and explaining how to allow access as well as why access is being requested. Alternatively, the user (FIG. 1, 105) may access the account settings (230) button and direct the system (FIG. 1, 100) to send an invite to the honoree via the user's (FIG. 1, 105) email program on the user computing device (FIG. 1, 110). In this example, the invite may also inform the honoree of why the system (FIG. 1, 100) is requesting access and explaining how the honoree may provide that access.

With or without the event information from the user's (FIG. 1, 100) and honoree's calendaring programs, the user (FIG. 1, 100) may select the schedule an event (215) button to schedule a number of events to occur on behalf of the honoree. For example, the user (FIG. 1, 100) may select this button and be directed to another interface requesting form the user (FIG. 1, 100) a time and date that the user wishes to have a service provided to a user. For example, a user (FIG. 1, 100) may select this button and direct that a text message be sent to the honoree wishing him or her a happy birthday early in the morning of the honoree's birthday. In this example, the user (FIG. 1, 100) may be directed to provide a personal message or select a previously generated message. In another example, the user (FIG. 1, 100) may schedule lunch reservations with the honoree at or around noon. In yet another example, a user (FIG. 1, 100) may schedule a movie or concert to attend with the honoree.

In each of the above selections, the user (FIG. 1, 100) may, after choosing a date and time, be directed to a user interface similar to a user interface if the user (FIG. 1, 100) had selected the choose a service (220) button. Here, the user (FIG. 1, 100) may be directed to select which service provider among a number of service providers to execute the selected service request. In this case, because the user (FIG. 1, 100) had previously determined the nature of the event (e.g. send flowers, send email message, send text message, get reservations, etc.), the system (FIG. 1, 100) may determine based on the nature, features, and text of the proposed event, direct the user (FIG. 1, 100) to a number of service providers who are capable of providing that particular service.

Actuation of the choose a service (220) button may direct the user (FIG. 1, 100) to another user interface where the user (FIG. 1, 100) may choose a service before choosing a particular date or time that the service is to be provided. As briefly described above, the user (FIG. 1, 100) may be directed first to a user interface describing all types of services available to the user (FIG. 1, 100). Selection of a type of service may then further direct the user (FIG. 1, 100) to another user interface with a list of third-party service providers which can provide that type of service. After selection of a third party service provider and entering into a contract with the service provider, the user (FIG. 1, 100) may then be directed to an interface similar to the interface provided to the user (FIG. 1, 100) after actuating the schedule an event (215) button. In this case, the user (FIG. 1, 100) may select a time and date on which the service is to be provided to or on behalf of the honoree.

The user log in (225) may provide a user (FIG. 1, 100) with the ability to access his or her account. Selection of this button directs that user (FIG. 1, 100) to provide a username and password or any other authentication information.

Although FIG. 2 shows a specific layout of a user interface (200), the depicted user interface (200) is merely an example and the present specification contemplates that the user interface (200) may comprise more or less options to present to the user (FIG. 1, 100) according to the system (FIG. 1, 100) and methods described herein. The user interface (200) may be presented to the user on the output device (FIG. 1, 114) using any type of operating system including, but not limited to, a Windows® operating system, a LINUX® based operating system, and a UNIX® based operating system, among others.

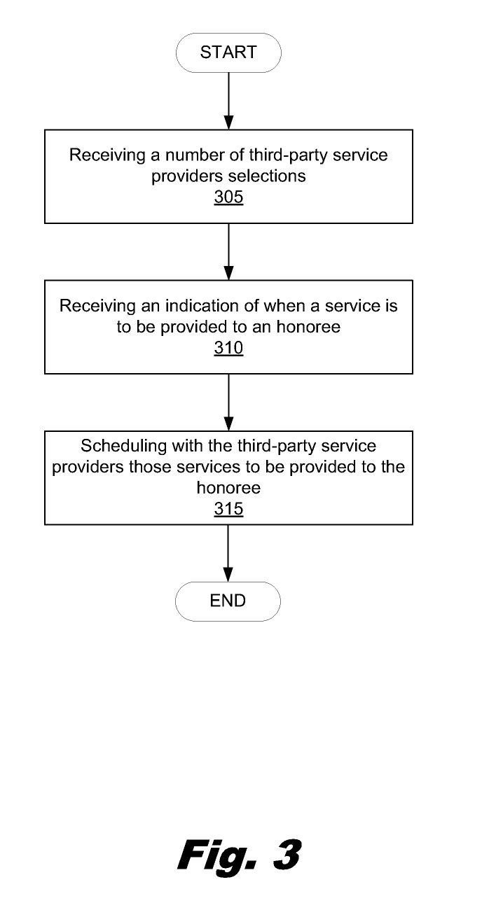

Turning now to FIG. 3, a flowchart describing a method (300) of coordinating a number of celebratory events for an honoree is shown according to one example of principles described herein. The method (300) may comprise receiving (305), from a user (FIG. 1, 105), a number of third-party service providers selections. In one example, receiving (305) a number of third-party provider selections from a user (FIG. 1, 105) comprises first receiving a selection of a type of service and then receiving a selection for a specific third-party service provider within that type of service.

The method (300) may further comprise receiving (310), form a user (FIG. 1, 105), an indication of when a service is to be provided to an honoree. As described above, this may further comprise comparing both a user's (FIG. 1, 105) and honoree's schedule on their respective calendaring programs being executed in their respective computing devices (FIG. 1, 110) with the time scheduled for the event by the user (FIG. 1, 105). The system (FIG. 1, 100) may then warn or alert a user (FIG. 1, 105) of any scheduling conflicts that arise while scheduling the events planned on behalf of the honoree.

The method (300) may further comprise scheduling (315) with the third-party service providers those services to be provided to the honoree. The server (130) may provide the third-party service providers with confirmation of a purchase service and may serve as a central location from which the third-party service providers may receive instructions and payment from the user (FIG. 1, 105).

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (120) of the computer (110) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The present specification therefore contemplates a computer program product for coordinating a number of celebratory events for an honoree, the computer program product comprising a computer readable storage medium comprising computer usable program code embodied therewith. The computer usable program code may comprise computer usable program code to, when executed by a processor (FIG. 1, 185), receive a number third-party service providers selections from a user (FIG. 1, 105). The computer usable program code may further comprise computer usable program code to, when executed by a processor (FIG. 1, 185), receive an indication of when a service is to be provided to an honoree from a user (FIG. 1, 105) of the user computing device (FIG. 1, 110). The computer usable program code may comprise computer usable program code to, when executed by a processor (FIG. 1, 185), schedule with the third-party service providers those services to be provided to the honoree which were received from the user (FIG. 1, 105).

The specification and figures describe a system and method for coordinating a number of celebratory events for an honoree. The system may have a number of advantages, including providing to a user a single location at which to purchase and coordinate a number of services on behalf of an honoree. This allows an entire day to be used to celebrate an honoree's special event regardless of events that may already be planned by the honoree during the day. A number of services may be provided throughout the day such as email messages, text messages, reservations for breakfast, lunch or dinner, reservations for movies or concerts, and general notifications to other persons associated with the honoree that the day is a day to celebrate.

The preceding description has been presented to illustrate and describe examples of the principles described. This description is not intended to be exhaustive or to limit these principles to any precise form disclosed. Many modifications and variations are possible in light of the above teaching.

What is claimed is:

1. A central server for coordinating a plurality of celebratory event for an honoree comprising:
a processor;
a data storage device communicatively coupled to the processor;
a user selection module to provide a user accessing the central server with a selection among a plurality of services to support the celebratory event;
a third party selection module to provide the user with a plurality of third party services to support the celebratory event the third party services being provided from a plurality of third party service providers; and
a calendar coordination module to provide the user with a selection of when the services are to be provided to the honoree.

2. The central server of claim 1, in which the calendar coordination module coordinates selected services using a first calendaring program on a first computing device operated by the user and in which the time that the services are to be provided to the honoree are coordinated with any events already on the first calendaring program.

3. The central server of claim 2, in which the calendar coordination module alerts the user when the selected time to provide the services are in conflict with an existing scheduled event on the first calendaring program on the first computing device.

4. The central server of claim 2, in which coordinating selected services using the first calendaring program on the first computing device operated by the user further comprises the calendar coordination module receiving authorization from the user to access the first calendaring program on the first computing device.

5. The central server of claim 2, in which the calendar coordination module coordinates selected services with the honoree using a second calendaring program on a second computing device operated by the honoree in which the time that the services are to be provided to the honoree are coordinated with any events already on the second calendaring program.

6. The central server of claim 5, in which the calendar coordination module alerts the user when the selected time to provide the services are in conflict with an existing scheduled event on the second calendaring program on the second computing device.

7. The central server of claim 5, in which coordinating the selected services using the second calendaring program on the second computing device operated by the honoree further comprises the calendar coordination module receiving authorization from the honoree to access the second calendaring program on the second computing device.

8. The central server of claim 1, in which the third party selection module:
provides the user of the first computing device with a number of categories defining a number of types of services; and
upon selection of a type of service by the user, provides to the user a list of the third party service providers that are able to provide the type of service selected by the user.

9. The central server of claim 1, further comprising an account managing module, in which the account managing module:
receives data from a first computer operated by a user to access an account associated with the user;
provide the user with details about current and past selected services; and
maintain data associated with the user's payment method.

10. A computer program product for coordinating a number of celebratory events for an honoree, the computer program product comprising a computer readable storage medium comprising computer usable program code embodied therewith, the computer usable program code comprising:
computer usable program code to, when executed by a processor, receive a number of third-party service providers selections from a user of a first computing device;
computer usable program code to, when executed by a processor, receive an indication of when a service is to be provided to an honoree as celebratory events from a user of the first computing device; and
computer usable program code to, when executed by a processor, schedule with the third-party service providers those services to be provided to the honoree which were received from the user.

11. The computer program product of claim 10, further comprising computer usable program code to, when executed by a processor, coordinate with a first calendaring program on the first computing device any events already on the first calendaring program with a time that the service is to be provided to the honoree.

12. The computer program product of claim 10, further comprising computer usable program code to, when executed by a processor, coordinate with a second calendaring program on a second computing device associated with the honoree any events already on the second calendaring program with a time that the service is to be provided to the honoree.

13. The computer program product of claim 12, further comprising computer program code to, when executed by a processor, alert the user of the first computing device when the celebratory events are in conflict with a scheduled event on the second calendaring program on the second computing device.

14. A method of coordinating a plurality of celebratory events for an honoree on a central server comprising:
receiving a number of third-party service providers selections from a user of a first computing device;
receiving an indication from the first computing device of when a service is to be provided to an honoree as a celebratory event; and
scheduling with the third-party service providers those services to be provided to the honoree;
in which scheduling with the third-party service providers those services to be provided to the honoree comprises:
coordinating the celebratory events with the user using a first calendaring program on a first computing device operated by the user and in which any events already on the first calendaring program are coordinated with a time that the services are to be provided to the honoree; and
coordinates the celebratory events with the honoree using a second calendaring program on a second computing device operated by the honoree in which any events already on the second calendaring program are coordinated with a time that the services are to be provided to the honoree.

15. The method of claim 1, in which receiving a number of third-party service providers selections from a user of a computing device further comprises:
providing the user of the computing device with a number of categories defining a number of types of services; and
upon selection of a type of service by the user, providing to the user a list of third-party service providers that are able to provide the type of service selected by the user.
